(19) United States
(12) Patent Application Publication
(10) Pub. No.: US 2022/0300481 A1
(43) Pub. Date: Sep. 22, 2022

(54) METHOD AND SYSTEM FOR CONTENT EDITING RECOGNITION

(71) Applicant: Mansoor Anwar Ahmed, Colwyn Bay (GB)

(72) Inventor: Mansoor Anwar AHMED, Colwyn Bay (GB)

(21) Appl. No.: 17/463,647

(22) Filed: Sep. 1, 2021

Related U.S. Application Data
(60) Provisional application No. 63/161,773, filed on Mar. 16, 2021.

(51) Int. Cl. G06F 16/23; G06T 7/00; G06F 16/48; G06F 16/215

(52) U.S. Cl. CPC G06F 16/2365; G06T 7/0002; G06F 16/48; G06F 16/215; G06T 2207/10016; G10L 25/51

(57) ABSTRACT

A content editing recognition tool for incorporating legitimate edits and detecting any illegitimate edits to any content such as video, audio or image file. The content editing recognition tool majorly works on three components namely a source/pre-edit file, an edit record and a post-edit file. The tool applies the edits mentioned in the edit record on the source file, and then matches the edited file with the post-edit file to verify/validate the content and determine any illegitimate edits in the file to be consumed by the user. Additional features detect any false negatives while performing content validation. Also, the content editing recognition tool helps in detecting deepfakes and distinguishing between trustworthy and untrustworthy videos, photos and audio files.

### FIELD OF INVENTION

The present application relates generally to the field of content verification. More specifically, the present invention relates to a content verification tool that enables the users to incorporate legitimate edits and detect any illegitimate edits to any content such as video, audio or image file.

### BACKGROUND

By way of background, machine learning technology has become more mainstream and is utilized in a wide range of applications for providing solutions to complex problems efficiently, effectively and quickly. While the machine learning techniques are used to provide constructive solutions to problems of the individuals, the usage of machine learning techniques have negative consequences too. As an example, the machine learning techniques are used to create deepfakes. The term “deepfake” is typically used to refer synthetic or edited media in which a person in an existing image or video is replaced with someone else's likeness using various machine learning and artificial intelligence techniques. The main machine learning methods used to create deepfakes are based on deep learning and involve training generative neural network architectures, such as autoencoders or generative adversarial networks (GANs). Deepfakes are used in celebrity pornographic videos, revenge porn, fake news, hoaxes, financial fraud and many other work of fake content.

The deepfakes and other editing tools (including those that do not use machine learning but are operated by human editors) makes it difficult to distinguish between the real video, audio, images or other content from the fake ones. For the consumers, having minimal knowledge of such content fabrication technologies, it may be extremely difficult and nearly impossible to identify if the content is fabricated or not. Ordinary viewers may be unable to distinguish between trustworthy and untrustworthy videos, photos and audio files.

To overcome the issues faced by deepfakes, a number of specialized camera systems and computer programs/software tools are available in the state of the art. Such specialized camera systems and/or software tools attempt to either disallow edits or to detect edits in the content. However, the conventional specialized camera systems and software tools fail to distinguish between legitimate edits (such as subtitles addition, compression, etc.) and malicious edits (such as deepfakes, doctored interview, etc.). The conventional specialized camera systems and software tools only detect if any edit has taken place or not, and therefore even innocuous edits such as adding a filter will make these systems label an otherwise legitimate video as illegitimate. The currently available tools fail to provide a solution to the problems of recognizing fabricated or synthetic content.

Therefore, there exists a long felt need in the art for a system or a software program for performing technical analysis of the content such as audio, video and images. There is also a long felt need in the art for a software program or systems for distinguishing between real and fabricated content. Additionally, there is a long felt need in the art for a content verification mechanism for content such as audio, video, images or other content types. Moreover, there is a long felt need in the art for a content verification application which enables the users to distinguish between legitimate and malicious edits. Further, there is a long felt need in the art for a content verification application which can be easily used by ordinary consumers or individuals for technical analysis of the content. Furthermore, there is a long felt need in the art for a content verification application which is compatible with different platform configurations. Also, there is a long felt need in the art for a content verification application which supports different content types such as audio, video, images, etc. Finally, there is a long felt need in the art for a content verification application which enables the individuals to incorporate legitimate edits to any video, audio, or image file, and detects any illegitimate edits to the content without any false positives.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

In the present invention, a method for validating edits performed on a media file is described. The method includes the steps of receiving a source media file, receiving an edit record file, receiving a post-edit media file, retrieving edit records from the edit record file, applying retrieved edit records on the source media file to prepare an edited media file, comparing said edited media file with the post-edit media file, validating the differences in edits of the edited media file and the post-edit media file, determining if any differences are identified in the edits based on said validating step, notifying discrepancy if validation is unsuccessful and notifying a successful validation if no difference in edits is identified.

In yet a further embodiment of the present invention, the validation can be performed by a central computer. Alternatively, the validation can be performed by a distributed computer system.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of typical audio/visual content production pipeline for content editing tool of the present invention in accordance with the disclosed architecture;

FIG. 2 illustrates a diagrammatic view of different files utilized by the content editing recognition tool of the present invention for validating content in accordance with the disclosed architecture;

FIG. 3 illustrates a flowchart showing steps for validating content using content editing recognition tool of the present invention in accordance with the disclosed architecture;

FIG. 4 illustrates a flowchart showing detailed steps for validating content using content editing recognition tool of the present invention in accordance with the disclosed architecture; and

FIG. 5 illustrates a flowchart showing reconciliation process performed by the content editing recognition tool of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

The present invention, in one exemplary embodiment, is a novel software tool for distinguishing between a legitimate and an illegitimate edit in a piece of content. The software tool comprising components namely a source file, an edit record and a post-edit file, on which various steps for identifying a legitimate or illegitimate edit are performed. The novel content editing recognition tool allows the consumer and ordinary individuals to know whether any edits have been performed on the content or not.

In a further embodiment of the present invention, a method for recognizing a legitimate or an illegitimate edit in a video, audio or image file is disclosed. The method receives a pre-edit audio/video/image file, an edit record file and a post-edit file for the technical analysis and validation of edits in the audio/video/image. The method receives the pre-edit audio/video/image file as an input file and applies the edits disclosed in the edit record file on the pre-edit audio/video/image file. Once all the edits of the edit record file are applied on the pre-edit file, a processed pre-edit file is formed. Then, the processed pre-edit file is compared to the post-edit file. In the comparison step, in case the processed pre-edit file matches with the post-edit file, the files are successfully verified, else, the discrepancies in the post-edit file are notified to a user after a reconciliation process.

In an embodiment of the present invention, the edit record file and the pre-edit file may be a single combined file, and may not be separate files. As an example, an image which has intended edits in its EXIF metadata, may be considered as the pre-edit image file and the edit record file for content verification.

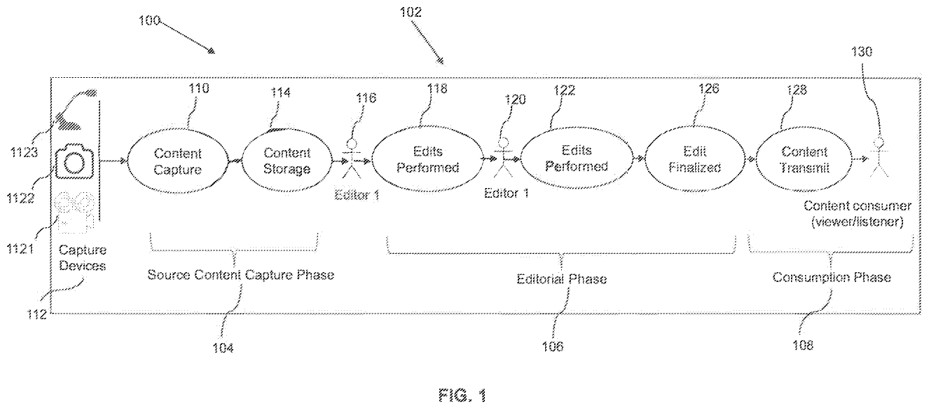

FIG. 1 illustrates a diagrammatic view of typical audio/visual content production pipeline for content editing recognition tool of the present invention in accordance with the disclosed architecture. As shown, FIG. 1 is an illustration of a typical content production pipeline 102 on which the content editing recognition tool 100 of the present invention operates to enable a user to know whether any edits have been performed on the content, and if so, then what kinds of edits have been performed on the content. The content editing recognition tool 100 enables the users to incorporate legitimate edits and detect any illegitimate edits to any content such as video, audio or image file.

The content production pipeline 102 comprises of three phases namely a source content capture phase 104, an editorial phase 106, and a consumption phase 108. The source content capture phase 104 consists of digitizing content, for example taking a picture or recording a voice call. The source content capture phase 104 involves the steps of content capturing 110 and content storage 114. Digitized content is captured using various content capturing devices 112 such as Video camera 1121, Camera 1122, Microphone 1123 or the like. The source content capture phase 104 stores the digitized content captured by the various capture devices 112 in various kinds of storage devices such as memory of any electronic devices, or any cloud based data storage. The content captured and stored in the source content capture phase 104 of the content production pipeline 102 is a source file used for content editing recognition tool of the present invention. The source file is a pre-edit file and ensures the content in the source file is original, with no editing performed any of the individuals.

In the editorial phase 106 of the content production pipeline 102, various kinds of transformations such as editing an image or a video, compression, adding annotations on an image, clipping a call recording, etc. are performed by a plurality of editors on the source file obtained from the source content capture phase 104. As shown in FIG. 1, a first editor 116 performs a first set of edits 118 on the source file and a second editor 120 performs a second set of edits 122 on the file 118 obtained from the first editor 116. The first editor 116 and the second editor 120 can perform various kinds of transformations on the source file. Alternatively, the second editor 120 can perform editing on the file 118 obtained from the first editor 116. In an embodiment, the first editor 116 and the second editor 120 performs various transformations in a distributed computing environment.

In an embodiment of the present invention, editors 116, 120 can perform several operations in parallel, for example, several editors 116, 120 may work on the same file simultaneously before merging back the edits. Once the edits are performed by the editors 116, 120 and the edits done by all the editors 116, 120 and more are merged and finalized on the source file, a post-edit file 126 is retrieved at the end of the editorial phase 106.

In the editorial phase 106, the number of edits/transformations performed by the editors is not limited, and any number of edits/transformations can be performed by the editors as per the needs and requirements. Additionally, one or more editors can work independently or together in a distributed or single computing environment to transform the source file obtained in source content capture phase 104 of the content production pipeline 102.

In the content consumption phase 108, the transformed or edited content file 126 is retrieved from the editorial phase 106, that is transmitted 128 and presented to the content consumer 130 such as viewer, or listener. The consumption phase 108 establishes a communication session with the consumer 130 to transmit the content to the consumer 130 over any wireless communication medium such as Bluetooth, Wi-Fi, Internet or the like. For example, viewing an image on a social networking site, playing back the call recording on a speaker after transmitting it via Bluetooth, streaming any video content, playing back any video content and more.

The content editing recognition tool 100 of the present invention operates on the content production pipeline 101 disclosed in FIG. 1.

The present invention provides assurances of the provenance of edits for a piece of content from the ingress point to the egress point. The ingress point is defined as the point in time at which the pre-edit file was formed while the egress point is the point at which the content is consumed. The ingress point is not necessarily the same as the pre-edit file from source content capture phase 104, and can be the file at any point before the consumption phase 108.

It should be appreciated that, the content editing recognition tool 100 provides the editors 116, 120 the ability to incorporate legitimate edits to any video, audio or image file. Thus, as long as editor 116 is honest about disclosing what edits have been performed, the edits are accepted as legitimate. The content editing recognition tool 100 analyzes all the edits that are performed on the source file and validates the integrity measure associated with each edit to detect any illegitimate edits in the content consumed by the consumers.

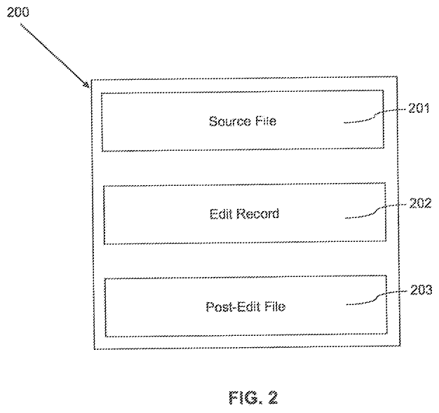

FIG. 2 illustrates a diagrammatic view of different files utilized by the content editing recognition tool of the present invention for validating content in accordance with the disclosed architecture. The content editing recognition tool 100 works on a plurality of files from different phases of the content production pipeline. Various files 200 are utilized and worked upon to validate any content and detect if the content comprises any legitimate or illegitimate edits.

A source file 201 is a pre-edit file generally captured by various capture devices such as microphone, camera, smartphones or any other electronic device capable of recording audio, video, image or other content file in the source content capture phase of the content production pipeline. The source file 201 comprises of audio, video, image or other similar type of content known in the state of the art. The source file 201 is received and stored before the editorial phase and it ensures the content in the source file 201 is original, with no editing performed any of the individuals. In an embodiment of the present invention, the source file 201 may have some edits performed immediately after capture or by the capture device itself that are considered inconsequential to the legitimacy of the content as defined by this invention (e.g. greyscale filters applied over photographs, frequency filters on audio files).

An edit record 202 is a file specifying all the edits, transformations and compressions performed on the source file 201. The edit record 202 can include a list of editing or transformation details recorded by one or more editors who performed the corresponding editing/transformation steps on the source file 201. The edit record 202 may or may not be instantiated as separate files.

In a preferred embodiment the edit record 202 can include all the transformations performed by different editors on the source or original file 201 in a single file. The file can be generated by listing the transformations in a file located on a central server, such that all the editors working on the source file 201 have access on the file located on the central server. Alternatively, different editors can share separate files with a list of their respective transformations, wherein the separate files can be merged together to form the edit record 202. The edit record 202 can maintain a relation between a type of transformation performed on the source file 201, such as editing, compression, or the like, identity of the editor who performed the transformation, and more.

In an alternate embodiment of the present invention, the editing information is encoded into a post-edit file 203 by use of watermarks or metadata encoding. In such scenarios, the edit record 202 is not shared as a separate file and is hidden in the post-edit file 203 that is accessible by the tool for content validation.

A post-edit file 203 comprises a processed audio, video or image file that is formed after the editing or transformation steps performed by one or more editors in the editorial phase of the content production pipeline. The post-edit file 203 is the final version of the source file 201 which is available for use for the consumers.

The content verification tool provides assurances of provenance of edits for a piece of content from the ingress point to the egress point. The ingress point is defined as the point in time at which the pre-edit file was formed while the egress point is the point at which the content is consumed. The ingress point is not necessarily the same as the source content capture phase in FIG. 1, it can be at any point before the consumption phase.

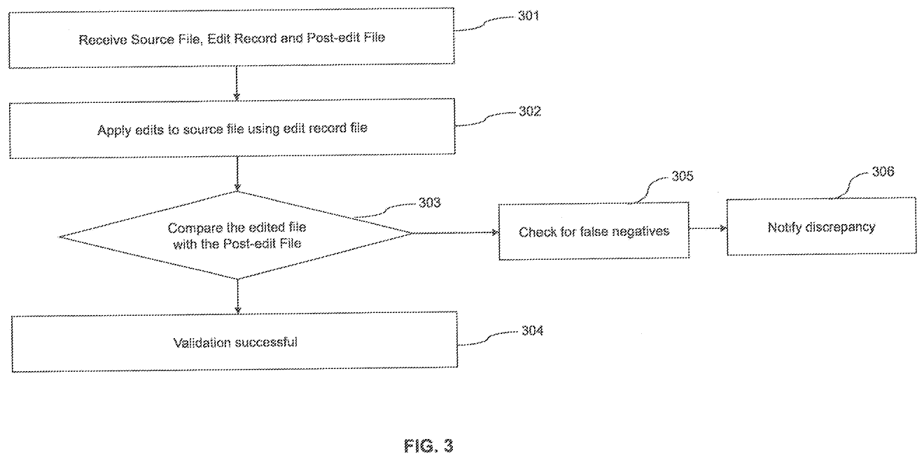

FIG. 3 illustrates a flowchart showing steps for validating content using content editing recognition tool of the present invention in accordance with the disclosed architecture. As shown, in step 301, a plurality of files including a source file, edit record and a post-edit file is received by the content editing recognition tool. In case the edit record is not stored as a separate file and the edits are encoded into the post-edit file, then a source file and the post-edit file is received by the content editing recognition tool. In step 302, all the edits disclosed in the edit record file are applied to the received source file to form an edited file as per the edits/transformations listed in the edit record. Next, once all the edits are applied to the source file, the edited or transformed file is compared to a post-edit file in step 303. In case, the edited or transformed file matches with the post-edit file, the validation is successful (Step 304). Alternatively, if the edited or transformed file does not matches with the post-edit file, the content editing recognition tool checks for any false negatives (Step 305) and accordingly notifies the users of any discrepancies found between the edits declared by the editors in the edit record and the edits found in the post-edit file (Step 306). The notification can be in the form of an error or a message that is sent to the consumer stating that any illegitimate edits are found in the source file.

The step of detecting false negatives (Step 305) can be performed by checking any platform differences, configuration differences and more. As an example, the false negative is detected in case a difference in the platform used while editing file and the platform on which content editing recognition tool is running are different, and the content editing recognition tool is showing differences due to platform differences. In such scenarios, the content recognition tool is capable of dealing with discrepancies caused by different platform settings. For example, the popular edit software MPEG uses different metrics for doing compression on ARM versus x86. This invention considers such discrepancies and reduces return of false negatives.

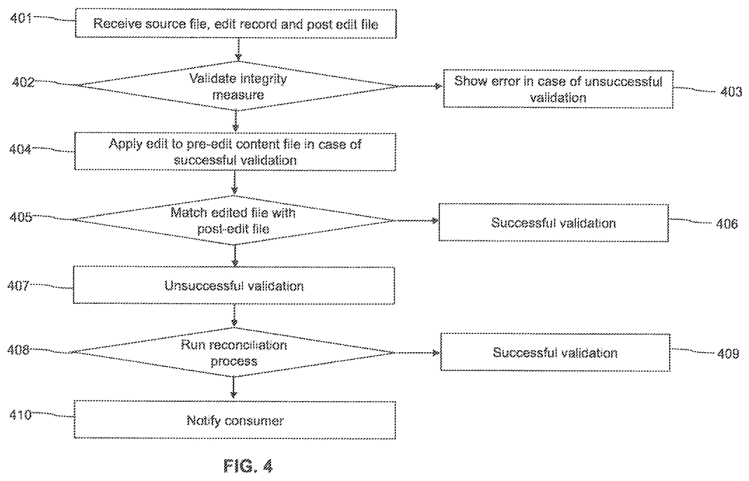

FIG. 4 illustrates a flowchart showing detailed steps for validating content using content editing recognition tool of the present invention in accordance with the disclosed architecture. In step 401, a source file, an edit record and a post edit file are received by the content editing recognition tool. Next, in step 402, an integrity measure validation is performed on each of the edits listed in the received edit record file and the post-edit content file. In integrity measure validation, the content editing recognition tool verifies the digital signature associated with each edit's editor or can check the values anchored to a trusted data structure such as a blockchain match. The methods for integrity measure validation are not limited, and other known methods can also be implemented. In case integrity measure validation checks for the edit record and the post edit file are successfully validated, the edits listed in the edit record are applied to a pre-edit/source file in step 404. Alternatively, in case the integrity measure checks fail for any of the files in step 402, then an error is shown or sent to the user regarding unsuccessful integrity measure validation in step 403.

In case of successful integrity measure validation, when all the edits are applied to the pre-edit/source file in step 404 to form an edited/transformed file, then the edited or transformed file is matched with the post-edit content file in step 405. If the edited/transformed file matches with the post-edit file, then the validation is successful and no illegitimate edits are found in the post-edit content file (as shown in step 406). However, in case the edited or transformed file fails to match with the post-edit content file, then the validation is unsuccessful (as shown in step 407), and the content editing recognition tool located some discrepancies or differences in the post-edit file with respect to the source file. In such a scenario, the content editing recognition tool runs a reconciliation process in step 408, to determine if the validation is unsuccessful due to some surreptitious edit or due to a configuration difference between the platform on which content editing recognition software or tool is hosted and the platform(s) used by the editor(s). If the reconciliation process succeeds, then the validation is successful (step 409) otherwise it has failed, and accordingly the consumer is notified in step 410. The reconciliation process is intended to reduce false positives due to trivial configuration differences. Some of these differences are due to platform differences, due to using different encodings, due to different compression algorithms and the like.

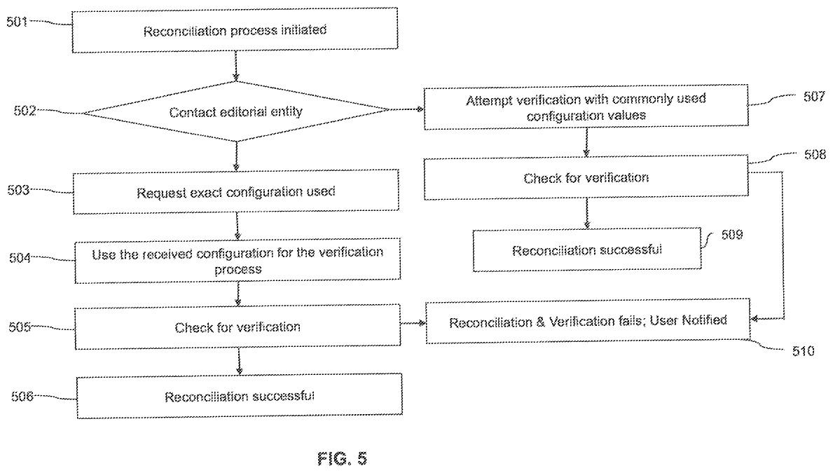

FIG. 5 illustrates a flowchart showing reconciliation process performed by the content editing recognition tool of the present invention in accordance with the disclosed architecture. The reconciliation process is initiated by the content editing recognition tool in case the edited file fails to match with the post-edit file. The reconciliation process determines if the edited file and the post-edit file did not match due to some surreptitious edit or due to a configuration difference between the platform on which the content editing recognition tool and the platform (s) used by editor(s). In case of mismatch between the edited file and the post-edit file, the reconciliation process is initiated (Step 501). The content editing recognition tool attempts to contact the editorial entity for which a mismatch between the edited file and the post-edit file is detected. The address for that entity may be stored in a lookup server, an edit file, a blockchain, etc. (Step 502). In case the content editing recognition tool is able to contact the editorial entity, then the content editing recognition tool requests exact configuration used by the editorial entity while performing the edits on the source/pre-edit file (Step 503). In response to the request for configuration information from the editorial entity, the content editing recognition tool receives the configuration information for the editorial entity, and uses the received configuration information to attempt the content verification (Step 504). Using the received configuration information the content verification is performed (Step 505). In case the verification succeeds for all edits then reconciliation is successful (Step 506). Alternatively, in case the verification fails using the configuration information received from the editorial entity, then reconciliation process and content verification fails, and accordingly the user is notified (Step 510).

In the step 502, in case the content editing recognition tool fails to contact the desired editorial entity, then the content editing recognition too attempts verification using commonly used configuration values (Step 507). The commonly used configuration values may be crowd sourced, based on third party lists, the Edits file, input by the administrator, or specified by the consumer. Using the commonly used configuration values, content verification is performed (Step 508). If the verification succeeds, then the reconciliation is successful (Step 509). Else, the reconciliation process and content verification fail, and the user is notified accordingly (Step 510).

The complete validation process is not limited to run on a single computer and different processes may be distributed to run on different computing systems to improve throughput, load balancing, etc. In an embodiment, the content editing recognition process can be run in a distributed setting to improve the overall performance of the process. This includes not just receiving the source, edit and post-edit files from distributed sources but also the actual processing of those files. In an embodiment, multiple content editing recognition processes may be simultaneously running on multiple computers. As an example, Process A could be assigned all overlay tasks, Process B could be assigned all compression tasks and so on.

Further, as a part of the verification process, validating the integrity of records may involve interacting with other entities. For example, in scenarios where hashes of the edits in the edit record are committed to a blockchain, then the content editing recognition tool would not only validate the edit entry but also check that the hash on the blockchain corresponds to the edit in the edit record.

Additionally, the provenance information about the edit record may be incorporated from third party sources. This could include trusted servers or distributed stores such as a blockchain. As blockchains guarantee immutability of data, so, the blockchain can be used for storing edit records, source content files and final content files.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented method for validating edits performed on a media file, comprising:
receiving a source media file;
receiving an edit record file;
receiving a post-edit media file;
retrieving edit records from the edit record file;
applying said retrieved edit records on said source media file to prepare an edited media file;
comparing said edited media file with said post-edit media file;
validating the differences in edits of the edited media file and the post-edit media file;
determining differences in the edits based on said validating step;
notifying discrepancy if validation is unsuccessful; and
notifying a successful validation if no difference in edits is identified.

2. The method of claim 1, wherein the validation is performed by a central computer system.

3. The method of claim 1, wherein the validation is performed by a distributed computing environment.

4. The method of claim 1, further comprising verifying digital signature associated with one or more editors of the post-edit media file.

5. The method of claim 1, further comprising matching of data stored or anchored to a blockchain.

6. A computer-implemented method for validating edits performed on a media file, comprising:
receiving a source media file;
receiving an edit record file;
receiving a post-edit media file;
retrieving edit records from the edit record file;
applying said retrieved edit records on said source media file to prepare an edited media file;
comparing said edited media file with said post-edit media file;
validating the differences in edits of the edited media file and the post-edit media file;
determining differences in the edits based on said validating step;
reconciling the detected edit differences determined during the validation step; wherein the reconciliation includes contacting an editorial entity or one or more third party sources for which the validation has failed, requesting configuration used by the editorial entity; and
performing validation using the requested configuration.
